(19) United States
(12) Patent Application Publication
(10) Pub. No.: US 2016/0130809 A1
(43) Pub. Date: May 12, 2016

(54) LOAD BEARING INTERLOCKING STRUCTURAL BLOCKS AND METHODS OF MANUFACTURE

(71) Applicant: JUST BIOFIBER CORP., Calgary (CA)

(72) Inventor: MAC RADFORD, Ainsworth (CA)

(21) Appl. No.: 14/815,829

(22) Filed: Jul. 31, 2015

Related U.S. Application Data
(60) Provisional application No. 62/032,192, filed on Aug. 1, 2014.
(60) Provisional application No. 62/100,790, filed on Jan. 7, 2015.

(51) Int. Cl. E04C 1/39; B28B 1/00; B28B 1/52; E04C 1/40; B28B 1/14

(52) U.S. Cl. CPC E04C 1/39; E04C 1/40; B28B 1/14; B28B 1/523; B28B 1/525; B28B 1/002

(57) ABSTRACT

Construction materials intended for use as structural elements, such as structural blocks, used in the construction of buildings and civil engineering structures. The blocks can comprise hemp hurd and fibers, flax fiber, hydraulic lime and hydrated lime. In one aspect, the blocks may comprise a body shape configured so as to allow it to interlock with other blocks in the construction of a structure. Methods for manufacturing the blocks and structures comprising such materials and methods for building such structures are also disclosed.

### FIELD OF THE INVENTION

The invention disclosed herein relates to particular construction materials, as well as processes for preparation and uses of such materials. Such materials may be intended for use as structural elements, such as structural blocks, used in the construction of buildings and civil engineering structures.

### BACKGROUND OF THE INVENTION

The production of blocks for masonry using vegetal additions incorporated in a lime-based binder matrix (for example hemp used to produce Chanvribloc™ blocks) is a known process in the art.

The prior art also discloses blocks used in the construction of structures, such as houses and commercial buildings, which may have properties that are either insulating or load bearing.

WO 2014072533 discloses an insulating construction material with an alleged low thermal conductivity comprising vegetal additions, as well as to a process for preparation and to uses of such a material.

It would be advantageous for there to be a structural block that had a composition and configuration that integrated both load bearing capabilities with insulating properties.

It would also be advantageous for there to be further means for providing additional reinforcement and tension bearing capabilities to a structural block.

### SUMMARY OF THE INVENTION

The invention disclosed herein relates to particular construction materials, as well as processes for preparation and uses of such materials. Such materials may be intended for use as structural elements, such as structural blocks, used in the construction of buildings and civil engineering structures. When the materials are used in the production of structural blocks, such blocks may integrate load bearing capabilities together with insulating properties.

In accordance with an aspect of the present invention, structural blocks are provided that may be configured to interlock with complimentary blocks in the construction of a structure. In one embodiment, the structural block may accommodate an embedded member or strut protruding from the surface of one side of the block and a recess on another side.

In accordance with a further aspect of the present invention, a method for manufacturing an interlocking structural block is provided, comprising positioning a plurality of members into a mold, such that one end of a member extends from one surface of the structural block with an opposite end of the member terminating partway within the structural block, wherein the mold is adapted for forming a plurality of apertures extending within the structural block from an opposing surface of the structural block, the apertures adapted for engaging with an extending end of an adjacent structural block, mixing a primarily fibrous material with a primarily lime based material for forming a block composition, applying the block composition into the mold, curing the block composition in the mold, such that the block composition is allowed to form around the plurality of members, injecting a quantity of carbon dioxide into the block composition and setting the block composition in the mold for a predetermined period of time.

In accordance with a further aspect of the present invention, a method for manufacturing an interlocking structural block is provided, comprising positioning a plurality of members into a mold, such that one end of a member extends from one surface of the structural block with an opposite end of the member terminating partway within the structural block, wherein the mold is adapted for forming a plurality of apertures extending within the structural block from an opposing surface of the structural block, the apertures adapted for engaging with an extending end of an adjacent structural block, mixing hemp hurd, flax, hydraulic lime and hydrated lime for forming a block composition, applying the block composition into the mold, compressing the block composition, compressing the block composition, curing the block composition in the mold, such that the block composition is allowed to form around the plurality of members, injecting a quantity of carbon dioxide into the block composition, and setting the block composition in the mold for a predetermined period of time.

Further aspects, features and advantages of the present invention will be apparent from the following descriptions and claims.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and accompanying drawings in which:

FIG. 1 is a front perspective view of a structural block in accordance with the present invention;

FIG. 2 is a rear perspective view of the structural block of FIG. 1;

FIG. 3 is a cross sectional side view of the structural block of FIGS. 1-2;

FIG. 4 is a front perspective view of an alternate structural block comprising conduits therethough;

FIG. 5 is a rear perspective view of the structural block of FIG. 4;

FIG. 6 is a cross sectional front view of the structural block of FIG. 5;

FIG. 7 is a front perspective view of a structural block adapted to accommodate a tensioning system therethrough in accordance with the present invention;

FIGS. 8-9 show alternate perspective views of structural blocks adapted to accommodate a tensioning system in accordance with the present invention;

FIG. 10 is a perspective view of an embodiment of a tensioning system comprising a hex swage tensioner in accordance with the present invention;

FIG. 11 is a front view of a structure comprising a plurality of structural blocks adjoined together through a tensioning system in accordance with the present invention;

FIG. 12 is a front close-up view of the structural blocks of FIG. 11;

FIG. 13 is a front view of an embodiment of a structural block adapted to accommodate a compression strut in accordance with the present invention;

FIG. 14 is a side view of the structural block of FIG. 13;

FIGS. 15-18 depict various views of a structure comprising structural blocks in accordance with the present invention;

FIGS. 19-22 show structural blocks comprising a variety of alternative configurations in accordance with the present invention;

FIG. 23 is a perspective view of a reinforcement means in accordance with the present invention;

FIG. 24 is a bottom view of the reinforcement means of FIG. 23;

FIG. 25 is a front view of the reinforcement means of FIG. 23;

FIG. 26 is a front view of a shear sleeve of the present invention;

FIG. 27 is a side cross sectional view of a reinforcement means incorporated within a structural block of the present invention;

FIG. 28 is a rear perspective view of a reinforcement means incorporated within a structural block of the present invention; and

FIG. 29 is a bottom view of a reinforcement means incorporated within a structural block of the present invention

### DESCRIPTION OF THE PREFERRED EMBODIMENT

The present invention relates to particular construction materials, as well as processes for preparation and uses of such materials. When describing the present invention, any term or expression not expressly defined herein shall have its commonly accepted definition understood by those skilled in the art. To the extent that the following description is of a specific embodiment or a particular use of the invention, it is intended to be illustrative only, and not limiting of the invention, which should be given the broadest interpretation consistent with the description as a whole.

The construction materials of the present invention are intended for use in structural elements for building structures and civil engineering structures.

In one embodiment, the materials are used in the production of structural blocks. In one aspect, the blocks of the present invention may be designed so as to integrate compression and torsional load bearing capabilities with insulation properties.

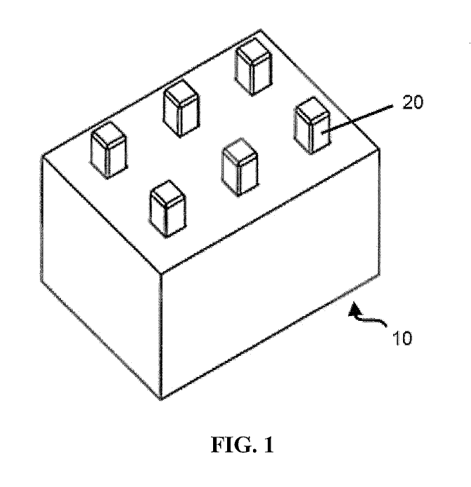

FIGS. 1-3 illustrate structural blocks 10 in accordance with preferred embodiments of the present invention. As illustrated in FIGS. 1-3, each block 10 of the present invention may comprise a body shape configured so as to allow it to interlock with other blocks when constructing a structure, such as a wall or house. Such design can provide further strength to the overall structure.

In one embodiment, each block 10 can accommodate one or more embedded member 20. The member 20, which may also be termed a strut in the art, may be embedded within the block 10 or inserted during building construction and may contribute to the load bearing properties of the block, particularly compression loads. One end of the embedded member 20 may protrude out a given distance from one side of the block 10, while the opposite end of the embedded member 20 may terminate partway within the block 10 on an opposite side.

In another embodiment, the embedded member 20 may be flush with the surface of the block and a positioning device may also be used to align and join the members together. For example, a tube with directional clips may be used between blocks to grip the abutting member ends in adjacent blocks.

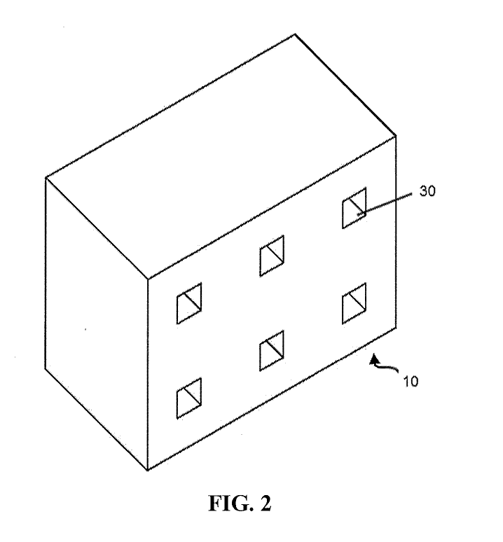

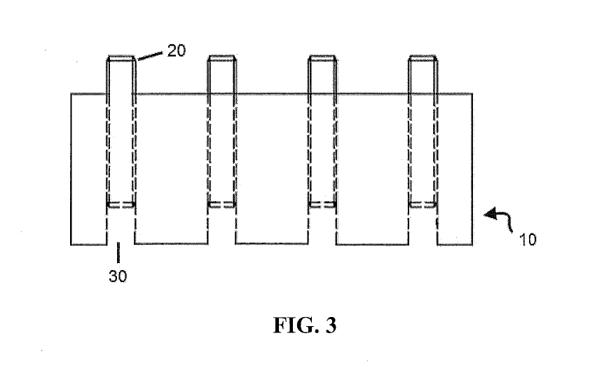

Referring back to the drawings, as depicted in FIGS. 2 and 3, a recess or opening 30 can be formed within the block 10 and can extend from the terminating end of the embedded member 20 within the block through to the surface of a side of the block 10, opposite to the side through which the embedded member protrudes.

In one embodiment, the extended end of the embedded member 20 may protrude from the block 10 by a distance that is approximately equivalent to the depth of the recess 30 within the block. By way of example, a block with a height of 8 inches may accommodate an embedded member that is 8 inches in length. The protruding end of the member may extend 2 inches out from the surface of one side of the block, with the remaining 6 inches embedded within the block. A recess formed within the block at the member's opposite end may be 2 inches in depth. The recess may extend immediately from the terminating end of the embedded member housed in the block, to the surface of the opposite side of the block.

A recess 30 can be of a size, shape and may be spaced apart from one another so as to align with and accommodate the protruding end of an embedded member of another block. Such an arrangement may be similar to an interlocking “pin and socket” arrangement and can function as a locating means for the purpose of accurately positioning a block with respect to an additional block(s) while also contributing to the load bearing attributes of the block under compression.

When the protruding end of an embedded member of one block is positioned into the corresponding recess of a second block, the protruding end of the embedded member may be in direct contact with the terminating end of the embedded member of the second block. As a result, the blocks can be said to auto align, and the embedded members can be said to form a stacked structure forming a load bearing structural member.

For ease of assembly, a recess within the block may have a width that is some measurement greater than the width of the embedded member. In one embodiment, the width of the recess may be ¼ inch wider than the width of the member, for example, ⅛ inches on either side of the recess (on each of the four sides when the block and recess are square), to accommodate ease of insertion of the protruding member of an adjacent block.

Any suitable binding agent, such as lime mortar for example, may be used to bind the protruding end of an embedded member of one block into the corresponding recess of a second block. Such a bond, when formed, may be stronger than the block itself.

When the embedded member and corresponding recess are interlocked, a molecular bond may be formed that can contribute to the load bearing or other structural properties of the block. In some instances, the load bearing capabilities of the block of the present invention may be several times greater than that of a hollow concrete block, and more similar to or exceeding that of a conventional stud-framed wall structure.

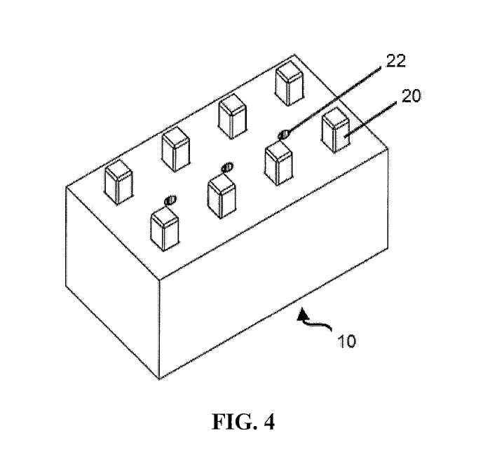

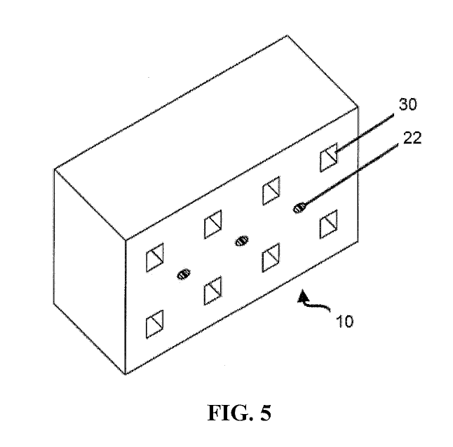

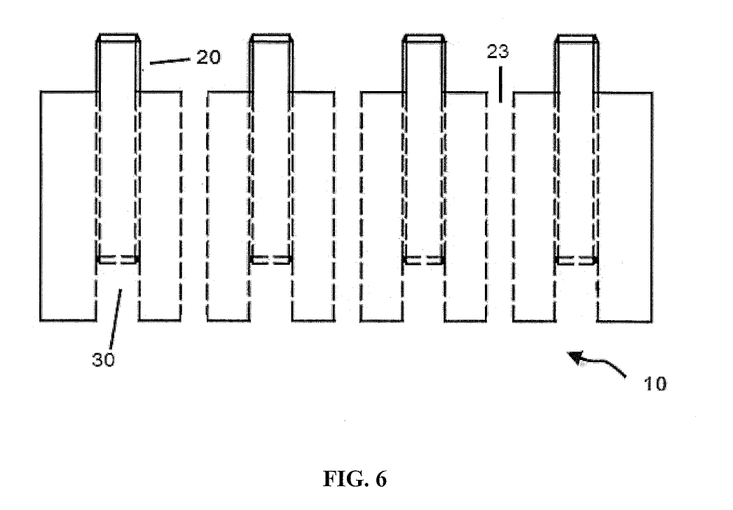

In another embodiment, holes 22 may be created on the block 10 that may be positioned an equal distance between the embedded members 20, as illustrated in FIGS. 4-5, the holes 22 may be used to create a conduit to accommodate electrical wiring or other utilities inside, for example, a structure's wall. The holes 22 may also be beneficial to the curing process, by exposing the block's interior, for example, to injected carbon dioxide. In an alternate embodiment, some strut members may be hollow and slotted. As illustrated in FIG. 6, in another embodiment, additional perforated tubes or struts 23 may be incorporated in the blocks 10 therethrough.

The composition of the member or strut 20 itself may comprise any rigid material or mixtures thereof, with any preferences to materials used directed to cost considerations and load bearing capabilities of the material. In a preferred embodiment, the embedded member may comprise any wooden material, such as fir, spruce, pine, cedar, etc. The element may also comprise composites of organic or inorganic fibers, such as hemp or carbon fiber, etc. In yet a further embodiment, the embedded member may comprise a blend of bio fibers and polymers, such as polyethylene, polypropylene or polyester. Some compatible metals may also be used. A member or strut may also be hollow, such as a hollow square or cylindrical tube. Other materials may include metals, carbon fibre or composites, 3D printed or extruded plastics or any suitable structural members.

Tensioning System

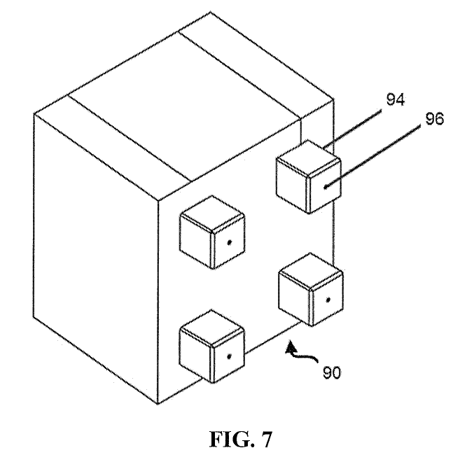

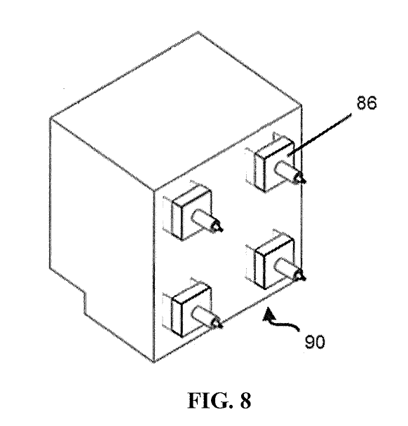

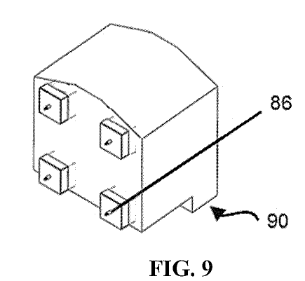

In one embodiment, the block of the present invention may be adapted so as to be tension bearing as well. As illustrated in FIGS. 7-12, a block 90 may be further adapted so as to accommodate a tensioning system that can provide tension. In such an embodiment, the embedded member 94 of the block 90 can accommodate a tensioning means 96 though the length of the member 94, such tensioning means entering through the one end of the member 94 and exiting through the other end of the member 94.

In one embodiment, the tensioning means 96 may be a cable, such as, for example, a tensioned non-stretch stainless steel cable. In an alternate embodiment, the system may comprise a rod.

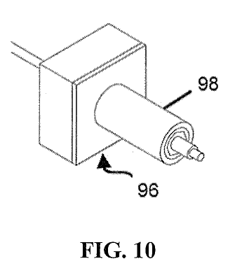

As illustrated in FIG. 10, when the tensioning system 96 includes a cable, the tensioning end assembly can comprise a hex swage tensioner 98, in addition to the cable.

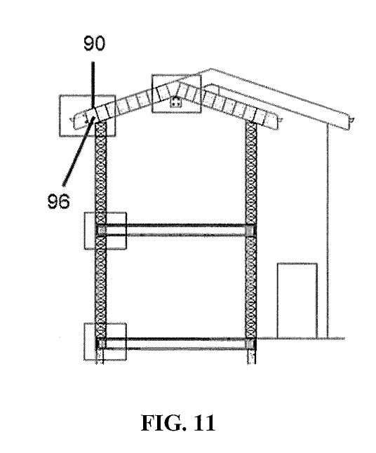

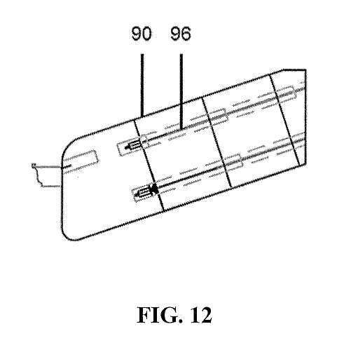

As illustrated in FIGS. 11-12, when assembled, the embedded members of each block can be aligned with the corresponding members of other blocks, to allow the passage of the tensioning means through multiple embedded elements and blocks.

Such a configuration provides a further fastening means for a structure comprising the blocks of the present invention. In particular, such a configuration may be tension bearing, in that the blocks may be adjoined together through tension suitable for non-vertical structural elements such as floors, walls, pitched or flat roof surfaces, etc.

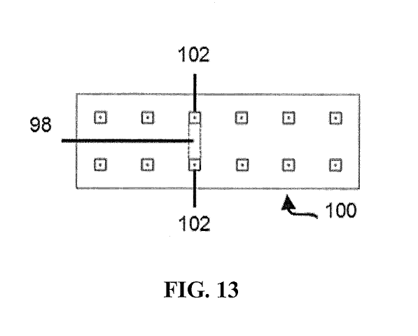

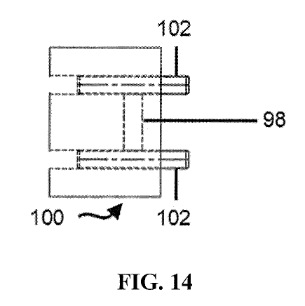

In another embodiment, an additional member, which may be termed a compression strut 98, can be used for the purpose of increasing the compression strength of the structural element formed by tensioned blocks. As illustrated in FIGS. 13-14, a compression strut 98 may, for example, be placed approximately perpendicular between and in contact with a pair of existing members or struts 102 integrated into the body of the block 100 each of which accommodates a cable as tensioning means. The application of the compression strut 98 in this embodiment may assist in keeping the embedded member pair properly spaced, without needing structure inherent in the block material, keeping the adjacent pairs of tensioned struts and cable or rod essentially equidistant throughout their length.

Other elements such as strut caps and/or mounting plates may be used in accordance with the present invention. By way of example, a strut cap may be set into a block over the protruding end of an embedded member, with the extending end extruding from the cap.

In practice, the tensioning means may be tensioned post construction, after the blocks have been aligned.

When the tensioning means comprises a cable, the tensioning procedure with regard to a roof, for example, may include the following steps:
(i) Beams may be assembled using the tension blocks on a flat horizontal surface and pre tensioned by use of cables and lifted into position. Alternatively scaffolding would be required to assemble in place and post tension the blocks using cables.
(ii) Once the roof is constructed (minus the end caps) the non-swaged end of the cable is fed through the embedded member, starting at the peak of the roof.
(iii) The cable is pulled taught.
(iv) The second end of the cable is swaged as close to the hex tensioner as possible.
(v) The hex tensioner is tightened as much as needed.

In one embodiment, the frequency of tensioning means may need be applied only as required, for example, every meter of the assembled structure, to form a floor, roof, or other non-vertical structure, or can be a wall.

Bio-Fiber Structural Block

In a preferred embodiment, the body of the block of the present invention can comprise a primarily fibrous and lime composition. Specifically, the composition for each block may comprise the following components:
(i) hemp hurd, and fibers
(ii) flax fiber
(iii) hydraulic lime
(iv) hydrated lime

Certain benefits may be realized through the practice of a block comprising the preferred composition of the present invention. Compositions comprising hemp hurd, flax, hydraulic lime and hydrated lime may be environmentally sustainable, recyclable and may sequester carbon dioxide from the atmosphere, while providing exceptional insulating qualities.

While a concrete block may need to be restricted in size, for example 16 inches, due to weight for handling, a block of the present invention may have a length of 48 inches or more and may maintain ease of handling because of its lower density, for example, 300 kg/cubic meter.

The lime component may primarily act as a binding agent, holding the other components together. However, any suitable binding agent may be substituted in instances, for example, when a stronger bonding agent may be required. Suitable alternative binding agents can include polymer based agents, for example silica sand, pozzolans, polyester resins, or Portland or similar cement or plaster. Such alternative agents may also be used in combination with the lime component of the preferred embodiment.

The hemp hurd and fiber component can provide insulating properties, bulk, support and strength to the block and structural members in the block. However, any alternate material or combination of materials that can provide similar desirable properties may be used in the alternative. Some organic alternatives include fibrous materials, such as corn stocks, cereal grain, straw, etc. Hemp hurd is a preferred material, primarily due to its insulating qualities in relation to the other fibers.

Alternatively, non-organic materials such as Styrofoam/polystyrene or non-recyclable plastics may be used. Such materials may also be used in a shredded form. Structural fibers (oriented cellulose strands, plastics, metal or carbon filaments) may also be incorporated or substituted. The application of these non-organic alternatives may provide an additional advantage, in that such non-recyclable materials may be sequestered from the environment, or may add different qualities to the blocks (strength, conductivity, electrical or RF shielding, noise abatement, etc.).

Recyclable and Sustainable

The composition of a preferred embodiment comprises hemp hurd, flax, hydraulic lime and hydrated lime. The primarily fibrous-lime combination is organic and composed of bio-recyclable material. When the useful life of a structure that uses such blocks comes to an end, its components may be recycled. For example, the entire block may be ground up and remixed for further subsequent applications.

The components of the composition are also sustainable. For example, hemp hurd, in addition to its favorable properties, is readily available in supply and grows very quickly with little water and fertilizer.

Other favorable properties may be realized by the fibrous-lime composition of the preferred embodiment. In particular, such a combination allows the building to “breathe”. Air and humidity can pass both in and out of the blocks at a very slow rate. No vapor barrier may be required to be used.

The composition may also be resistant to mold, termites and other insect pests.

A structure using the block composition of the preferred embodiment may allow for fire resistance, due to the properties of the hemp hurd and lime mixture, or other compositions.

In another embodiment, the blocks of the present invention may be further coated with a lime finish. A block of the present invention may be coated with several, for example five or more, coats of lime.

A structure using the blocks of the present invention can be bonded to become monolithic. Such properties can be especially beneficial particularly in areas prone to earthquakes, hurricanes or tornadoes.

Water proofing or moisture resistant properties may also be realized, particularly by use of the lime component. The lime component can also allow a block of the preferred embodiment to “heal” itself. For example, a crack in the lime coating can close over time when it is subjected to moisture.

Carbon Dioxide Sequestration

The carbon dioxide sequestration properties of a block that comprises the preferred composition of the present invention allows for the removal and sequestration of the greenhouse gas carbon dioxide from the Earth's atmosphere.

The hemp hurd component of the composition can sequester carbon dioxide at a rate of over approximately 20 tonnes per hectare as the plants grow.

It is estimated that the hemp hurd-lime composition blocks of the preferred embodiment have the capability to capture/absorb over approximately 100 kilograms of carbon dioxide per cubic meter. The lime component can use carbon dioxide to cure and set the mixture. An average house comprising such blocks, for example, can capture approximately 13,000 kilograms of carbon dioxide during block production and can continue absorbing carbon dioxide for approximately 100 years.

Methods of Manufacture

The fabrication of the blocks of the present invention may be attained by means using a mold process.

During manufacture, the embedded members or struts may be cut to the desired length, such as, for example, 8 inches in length. A hole may be drilled through the lengths of the bodies of those members that will serve as conduits for the tensioning means.

A desired number of struts and perforated tubes are placed into a mold at the desired positions, in a jig.

A mixture comprising the components of the block's composition may be combined and mixed. The mixture may then be, for example, poured, sprayed or injected into the mold.

The composition may be compressed and/or heated and allowed to set. During the curing process, carbon dioxide may be injected or passed by (or through conduits within) the curing block, which decreases the cure time. Depending on the lime composition used, the blocks may also be cured in an autoclave to control the temperature, humidity and carbon dioxide environment.

A lime coating may be applied to the inner and outer face of the blocks at time of manufacture which may increase the block strength and reduce construction finishing time.

The blocks of the present invention may be pre-manufactured and then cut as desired on site.

Building Structure and Related Materials

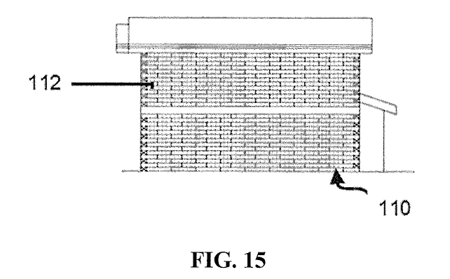

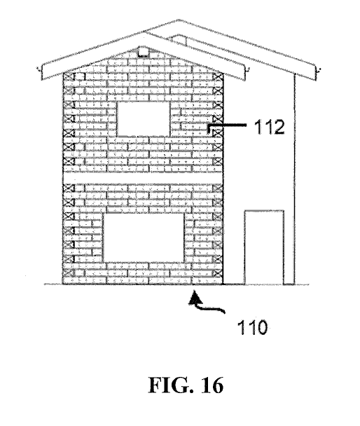

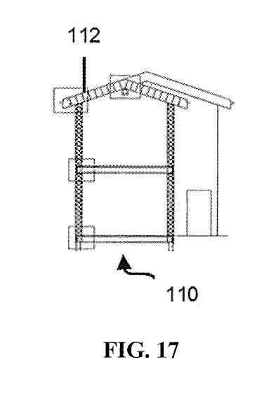

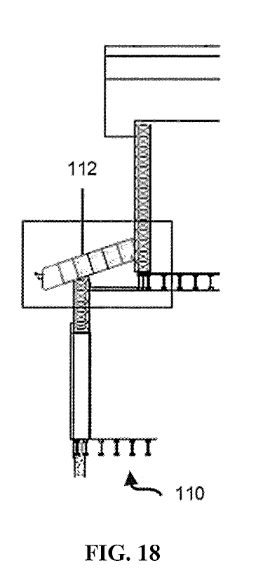

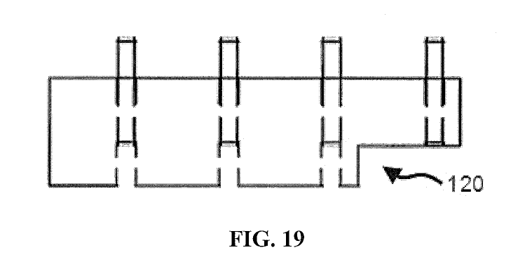

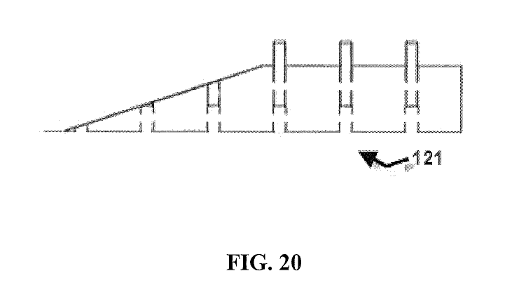

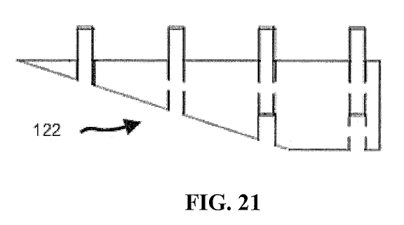

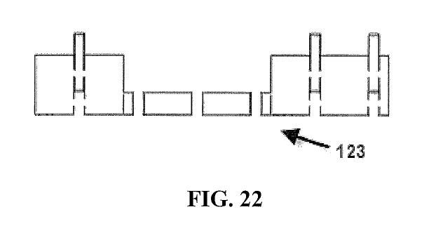

A structure 110 and related building materials is also disclosed by the present invention, as illustrated in FIGS. 15-18. FIGS. 19-22 depict structural blocks 120, 121, 122, 123 comprising a variety of alternative configurations, as examples.

In a preferred embodiment, such building materials may include blocks 112 as disclosed in the present invention. Consequently, the blocks used in the structure of the present invention may be load bearing, tension bearing and insulating.

The blocks 112 used may be of standard building construction dimensions. Height width and length may vary, depending upon the application, orientation and desired insulation requirements. For example, the blocks used for the walls of a structure may be a standard 11″ thick and 8″ high, while varying in length. Roof structure blocks may be 12″ high and 16″ wide.

The building materials may also be pre-manufactured prior to being transported to an intended building site for assembly.

A 1400 square foot house structure is provided by way of example below.

Wall Blocks

The wall blocks can be of a standard height and width, and may vary in the length. The wall blocks may be a standard 11″ deep and 8″ high, and may vary in the length. The total count below includes blocks that may be cut on site.

4″: 8

8″: 12

12″-2 struts: 13

12″-4 struts: 29

16″: 7

20″: 13

24″: 63

32″: 97

36″: 43

48″: 644

Total wall block count: 929

48″ wall starter strips—(may be made of pressure treated plywood): 65

Roof Blocks

R=roof

Ed=edge (always 48″)

S=starter

E=end

P=peak

Total counts include blocks that may be cut on site.

R24′: 1

R32″: 2

R48″: 198

Red: 20

Re24: 2

Re32: 1

Re48: 19

Reed: 2

Rs24: 1

Rs48″: 23

Rsed: 2

Rp24″: 2

Rp48″: 21

Rped: 2

Total roof block count: 296

Beam Blocks

Standard 16″: 36

16″ end block: 1

16″ end cap: 2

Standard 12″: 4

12″ end cap: 1

Total beam block count: 44

Structural Ties

Structural ties may be breathable and in one embodiment, may be made from 16 gauge stainless steel mesh.

Roof/Wall Structural Tie: 23

Peak tie: 30

Square mesh tie: 25

Structural bracket: 5

Wood (Rough Cut Unless Noted Otherwise)

1½″×12″×12″ under 12″ beam: 1

1⅝″×12″×16″ under 16″ beam: 2

2′×6′ roof starter block support (1 each):

37′-8″ long

35′-8″ long
11′-8″ long
2′ long

2×6 window/door headers and footers (dressed):
6′-4″ long: 2 (master bedroom window)
9′ long: 2 (living room window)
5′ long: 1 (front door)

8′-4″ long: 1 (back door/window)

3′-8½″ long: 1 (back window footer)

6′ long: 4 (bedroom windows)

2×4 window/door trim (dressed)
6′-8″ long: 4 (doors)
3′-4″ long: 8 (windows—not living room)
4′-8″ long: 2 (living room windows)

Fasteners

The fasteners used should be compatible with lime construction and can include stainless steel or ceramic coated fasteners.

Finish of the Structure

In an embodiment of the present invention, lime mortar or another suitable mortar may be brushed on all block faces that are adjacent to another block face. As a result, this can create a structure that is monolithic and sealed.

The interior walls of the structure of the present invention may be a lime rendering, which may be colored or have breathable paint applied over it. In an alternative embodiment, there is no further application required to the interior walls. In another embodiment, the interior walls may also be covered in panels of sheetrock, wood veneer or brick, preferably with approximately a minimum 1″ air space constructed between the bricks and the interior paneling.

The exterior walls of the structure of the present invention may have a plain coat bio-fiber and lime finish applied. Such an application can add to monolithic quality and building strength with a more finished look and a non-fading or fading resistant color finish. In another embodiment, the exterior walls can have a mortar application, or “stucco look”. Such an application can also add to monolithic quality and building strength with a more finished look and a non-fading or fading resistant color finish. In a further embodiment, typical wall siding brick veneer and other non permeable materials may be used, and should maintain a minimum 1″ space from the block surface. In yet another embodiment, there is no further application required to the exterior walls, and the blocks may be formed with a decorative exterior surface on them. The blocks may have embossed or patterned surfaces for decorative or other purposes such as sound absorption, water-shedding, light reflectivity and so on.

Any roofing material known in the art may be used in conjunction with the roof of the present invention structure. If non-breathable material is used, there should be an approximately one inch minimum space between the non-breathing material and the roof block. In one embodiment, the roof may be coated, for example, with a 7 coat, 100 year lime finish. In an alternative embodiment, the roof may further comprise bio-fiber breathable “clay-like” tiles which may not require an air space.

Preferred Proposed Block Benefits

A most preferred embodiment of the present invention would possess some or all of the following characteristics:
Strong load bearing capabilities
Excellent insulating properties R26 to R40 or λ=0.07 W/m·K with 100% thermal break
Excellent fire rating
Environmentally sustainable, Carbon zero or negative cot building material classification
Good thermal inertia and thermal mass characteristics to regulate inside temperature
Excellent air and humidity permeability
Conforms to existing building standards and dimensions making it easy for contractors and architects to implement. Conventional fasteners such as stainless steel or Ceramic coated screws may be used
Lightweight for ease of handling and requires no skilled labour for construction assembly
Very rapid construction, Constructed walls are weatherproof and finishes may be applied immediately. Factory prepared face surfaces require minimal interior and exterior finishing
Standard sizes may permit robotic or machine-assisted assembly at site
Integrated conduit paths within blocks to accommodate electrical and utilities

Integrated Reinforcement Means

In an alternate embodiment, the structural blocks of the present invention may comprise an additional reinforcement means. The reinforcement means can comprise an embedded, interconnecting structural webbing which may enhance the structural capabilities of a structural block. In a further embodiment, the structural blocks may accommodate one or more shear sleeves configured for engaging the embedded members of the present invention. In one embodiment, the structural blocks of the present invention may comprise both the interconnecting structural webbing and the shear sleeves. In yet a further embodiment, the structural webbing and shear sleeves may form a single integrated unit. Such an integrated reinforcement means may also be termed a structural shear web, which may be embedded within the binder/fiber matrix of the block's body.

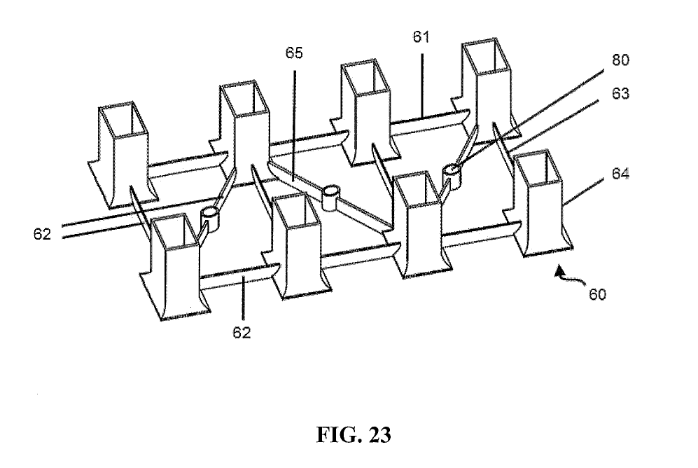

FIGS. 23-27 illustrate an integrated reinforcement means 60 in accordance with one embodiment of the present invention. In the embodiment depicted, the reinforcement means may comprise a plurality of web-like projections or arms 62 interconnecting with a plurality of shear sleeves 64 to form a single unit.

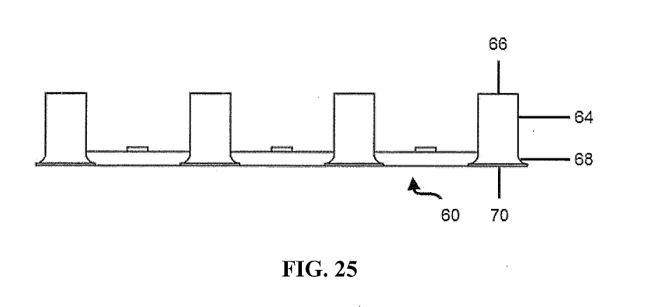

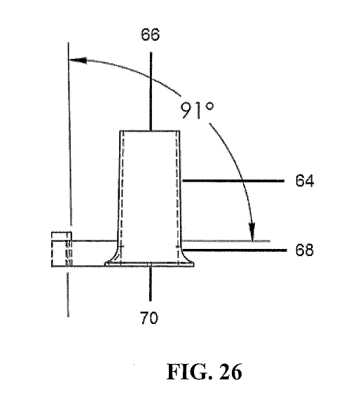

As depicted by FIGS. 23-27, an integrated reinforcement means 60 can comprise a plurality of shear sleeves 64. FIGS. 25-26, in particular, depict front and side views of the shear sleeves 64 in accordance with one embodiment of the present invention. As shown, a shear sleeve 64 may include an elongated hollow sleeve portion (or shank) terminating at a first sleeve end having a top opening 66 for receiving an embedded member, and terminating at a second sleeve end in an enlarged or lipped sleeve head 68, having a bottom opening 70 for receiving an embedded member of an adjacent structural block. Although a shear sleeve 64 may be in the form of a hollow square tube, this is by way of example only and other geometrical designs as required are contemplated. In an alternate embodiment, the shear sleeve 64 may, for example, be in the form of a cylindrical tube to mate with cylindrical members in such a block.

Shear sleeves 64 may be sized, shaped and spaced apart from one another so as to accommodate an embedded member within. In the embodiment depicted, the distance between adjacent shear sleeves 64 may be equal or approximately equal.

According to the embodiment depicted, an integrated reinforcement means 60 may be a single integrated unit with interconnecting structural webbing, as shown in FIGS. 23-27. In one embodiment, the structural webbing may comprise a plurality of web projections or arms 62 that can interconnect with shear sleeves so as to form a single structural unit. The web projections 62 may extend in a direction that is, or substantially is, vertical, horizontal and/or diagonal from a shear sleeve 64. The web projections may interconnect at any location of the shear sleeve. In one embodiment, the web projections may adjoin the sleeve at a location at or near the second sleeve end of the sleeve. In a further embodiment the web projections may adjoin enlarged preformed sleeve head 68 of a structural sleeve. In a further embodiment, the web projections adjoin or connect to an embedded member.

The structural webbing can generally be of any given width or design that allows for contributing to the tension bearing attributes of a structural block and to a wall or building component made of connected blocks. In one embodiment, the structural webbing may be approximately ⅛″ thick.

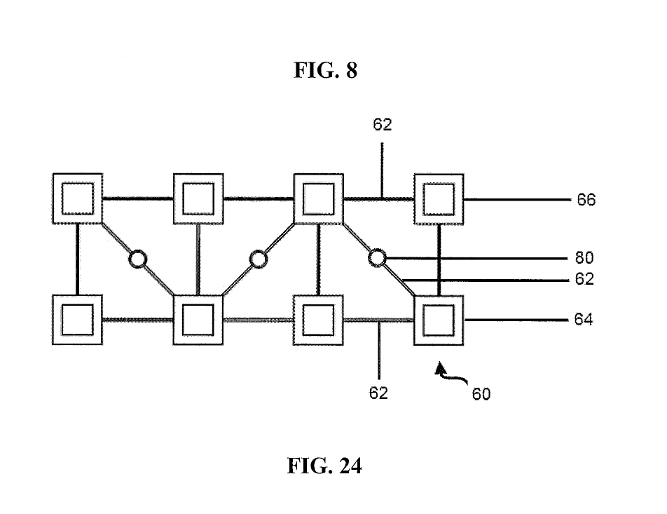

Referring back to FIGS. 23-24, in the embodiment depicted, particular web projections may further comprise a ring 80 situated at a point between the ends of a projection. A ring 80 may align, for example, with holes formed in a structural block used to create a conduit for accommodating electrical wiring or other utilities inside a structure's wall. In another embodiment, the rings 80 may align with additional perforated tubes or struts incorporated in the blocks therethrough (as illustrated in FIG. 6). In an embodiment, the inner diameter of a ring 80 may be equal or approximate to the outer diameter of the matter to be accommodated, such as perforated tubing, electrical wiring, etc.

The integrated reinforcement means 60 of the present invention can generally be formed of any materials that provide adequate shear strength and tensional loading strength while also contributing to the tension bearing attributes of a structural block. In an embodiment, the reinforcement means may comprise any generally rigid or non-stretchable, inelastic material. Some examples include, but are not limited to: polymeric materials such as silicone rubber, polyethylene, acrylic resins, polyurethane polypropylene and polymethylmethacrylate; synthetic and natural biodegradable polymers (biopolyesters, agro-polymers, etc.), copolymers; wooden materials; metallic materials; or any combination thereof, which may be incorporated with non-stretch fiber material of some sort.

In alternate embodiments, it may be beneficial to have the shear sleeves and interconnecting structural webbing made from a combination of materials. For example, in one embodiment, the shear sleeve 64 may be more malleable for accommodating possible radial expansion when engaging an embedded member, while still allowing for adequate shear strength. The interconnecting structural webbing on the other hand may require stronger properties for contributing to the tension bearing attributes. In an alternate embodiment, integrated reinforcement means 60 may be made from two or more different materials, and then assembled together to be integrated as a single component. In alternate embodiments, the shear sleeves and web support are separate components made from the same or different material(s) with either or both embedded within a structural block of the present invention.

Referring now to FIG. 26, depicted therein is an embodiment of a shear sleeve 64 of the present invention. A shear sleeve 64 may be of any variable geometry and diameter that is suitable for accommodating a particular geometry of an embedded member. In the embodiment depicted, a shear sleeve 64 may be of uniform diameter such that the outer wall of the sleeve 64 is straight and at, or approximately at, a 90° angle relative to the flat surface of the outer top surface of the preformed sleeve head 68. The geometry of the sleeve head 68 which terminates at the second sleeve end, may vary. In the embodiment depicted, the outer wall of the sleeve head 68, can be tapered outwardly. In alternate embodiments, for example, the sleeve head 68 may taper inwardly or the sleeve head 68 may be untapered and straight (or substantially straight), having the same or similar shape and/or diameter to the outer wall sleeve.

The first sleeve end may have an internal face configured for engagement with an embedded member. The second sleeve end may have an internal face that is configured for engagement with an embedded member of an adjacent structural block.

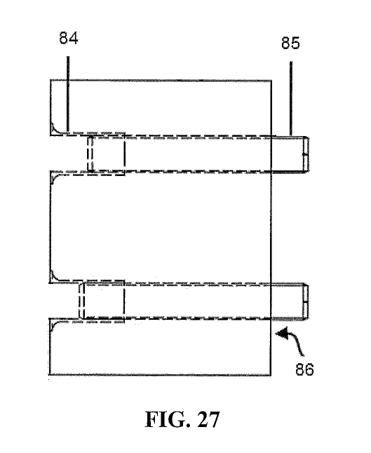

FIGS. 27-29 depict an embodiment of an integrated reinforcement means 81 incorporated within a structural block of the present invention. FIG. 27 particularly depicts the interlocking relationship between a shear sleeve 84 and an embedded member 85. The form and shape of a structural sleeve 84 may be designed so that its internal face may engage with the external surface of an embedded member 85 at or near its end.

As illustrated in FIG. 27, the opening at the first sleeve end of a shear sleeve 84 may be configured for accommodating one end of an embedded member 85, while the opposing end of the embedded member 85 may protrude a given distance from the structural block. The distance that an embedded member 85 may protrude from the structural block can vary. By way of example, a structural block with a height of 8 inches may accommodate an embedded member that is 8 inches in length, with the protruding end of the member extending 2 inches out from the surface of one side of the block. The remaining 6 inches may be embedded within the block, with the shear sleeve accommodating a given amount of the opposing end of the embedded member at the first sleeve end. In one embodiment, the shear sleeve may accommodate, for example, 2 inches of the opposing end of the embedded member at the first sleeve end.

In one embodiment, the opening at the outer bottom surface and the outer top surface of a structural sleeve may have a width that is some measurement greater than the width of an embedded member 85. In a particular embodiment, the width of an opening may be ¼ inch wider than the width of the member, for example, ⅛ inches on either side of the opening, to accommodate ease of insertion of the embedded member 85. In a further embodiment, the diameter of an embedded member 85 may be, for example, a few thousandths larger than the diameter of the opening in the shear sleeve 84, resulting in an embedded member being forced (i.e. interference fit) into an opening of the shear sleeve 84.

Adjacent structural blocks may interlock with one another such that the protruding end of an embedded member 85 of one structural block may engage the shear sleeve opening of a second block at a second sleeve end. In one embodiment, the protruding end of an embedded member of one block may come into direct contact with the terminating end of an embedded member of a second block, within the shear sleeve of that second block, or to an internal abutment in the void of the head-end of the sleeve.

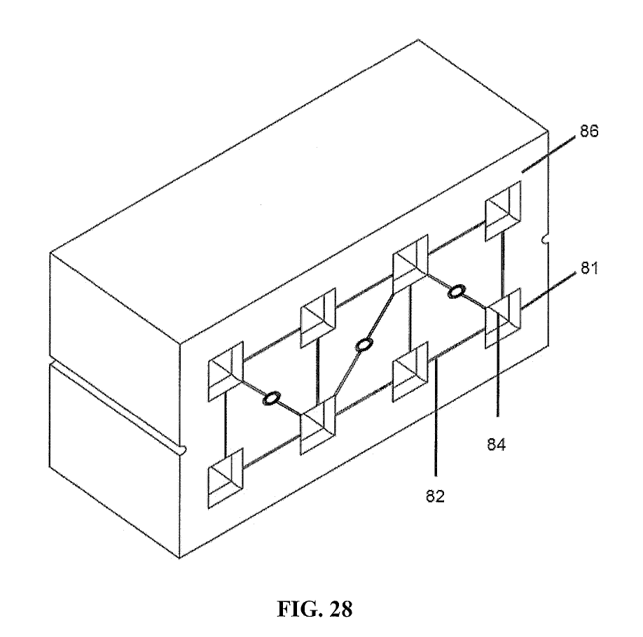

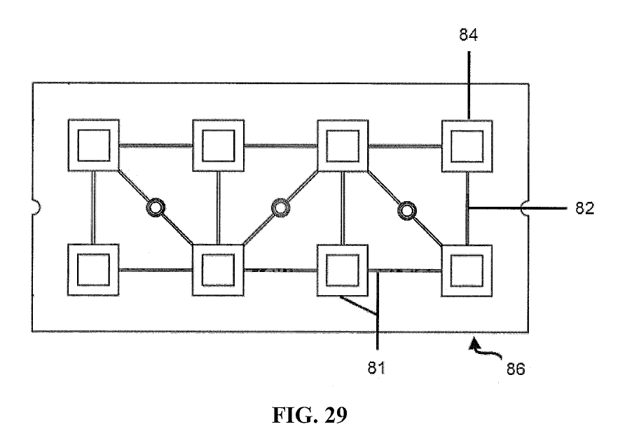

Referring now to FIGS. 28-29, depicted therein is a back view of an integrated reinforcement means 81 of the present invention together with a structural block. In the embodiment depicted, the integrated reinforcement means 81 may be embedded within the body of a structural block. The structural webbing 82 may be embedded flush with a surface of the structural block, which may provide further tension bearing support to the structural block and the eventual wall or structure made from the block. Also depicted are shear sleeves 84 which can be aligned with the opening or recess of the structural block. The enlarged or lipped sleeve head at the second sleeve end of the shear sleeve may be flush to the surface of the structural block.

Although the sleeve head may be in the form of a flush head design, as shown, this is by way of example only and other geometrical designs as required are contemplated.

### Methods of Manufacture

According to one aspect of the present invention, the integrated reinforcement means may be constructed through a manufacturing process that comprises an injection molding process. In accordance with one method of the present invention, the integrated reinforcement means may be injected molded in parts and subsequently sized or configured as required for integration within a structural block. In an alternate method, the integrated reinforcement means may be injection molded as a long strip, such as on a roll. The strip may then be cut and/or sized in accordance with the dimensions of a corresponding structural block for integration.

During manufacture, an embedded member may be cut to a desired length, such as for example, 8 inches in length. The desired number of members can be inserted into a corresponding number of shear sleeves and then fastened. The means for fastening an embedded member can include any suitable binding agent, such as lime or mortar; by way of adhesive agents such as glue; staples; or any other suitable fastening means.

A mixture comprising the components of the block's composition, such as for example, bio fiber, may be combined and mixed. The mixture may then be, for example, poured, sprayed or injected into the mold together with the reinforcement means.

The composition may be compacted or compressed and/or heated and allowed to set (for example, 4 hours). During the curing process, carbon dioxide may be injected or passed by the curing block. Depending on the lime composition used, the blocks may also be cured in an autoclave to control the temperature, humidity and carbon dioxide environment. The blocks of the present invention may be pre-manufactured and then cut as desired on site. Aspects of the manufacturing method provided in the examples above may be incorporated for embodiments in which only the structural webbing or shear sleeves are incorporated or embodiments which the structural webbing and shear sleeves do not form a single integrated unit.

The configuration of the reinforcement means incorporated with a structural block may afford certain additional benefits during manufacture and storage. Mechanical means, such as a liner robot, may pick the structural blocks up by the embedded members attached to the integrated reinforcement means after molding. In a particular embodiment, the bottom of the sleeves, such as at the enlarged or lipped sleeve head at the second sleeve end of the shear sleeve, may be flush to the surface of the structural block, as may the bottom side of an associated web. During curing or storage, structural blocks may be stacked a given height (such as 20 feet, 30 feet, etc.). The protruding upper end of an embedded member on a lower block will support the integrated reinforcement means on the bottom side of an upper block so as to allow a 2 inch space, for example, between the upper and lower blocks. As such, a smaller foot print of floor area may be required than, for example, the use of a roller system method. Racks and block handling for storage during block curing may also be reduced or avoided, and/or curing times reduced by providing inter-block circulation of air or air enhanced with CO₂.

The configuration of the reinforcement means incorporated with a structural block can also provide increased compression strength to a structural element formed by the blocks, including blocks adapted to accommodate a tensioning system, as illustrated in FIGS. 7-12.

The structural webbing can provide structural support and assist in keeping the embedded members of a structural block properly spaced so as to avoid the compressing together of the members, or in keeping adjacent pairs of tensioned struts and cable or rod essentially equidistant throughout their length, without needing structure inherent in the block material. In addition, the use of a compression strut, as depicted in FIGS. 13-14, may not be required.

By way of example, the structural web may make use of a compression strut between adjacent embedded members unnecessary during post or pre-tensioning in blocks adapted to accommodate a tensioning system, such as in roof or beam blocks.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention.

What is claimed is:

1. A method for manufacturing an interlocking structural block comprising:
positioning a plurality of members into a mold, such that one end of a member extends from one surface of the structural block with an opposite end of the member terminating partway within the structural block, wherein the mold is adapted for forming a plurality of apertures extending within the structural block from an opposing surface of the structural block, the apertures adapted for engaging with an extending end of an adjacent structural block;
mixing a primarily fibrous material with a primarily lime based material for forming a block composition;
applying the block composition into the mold;
curing the block composition in the mold, such that the block composition is allowed to form around the plurality of members;
injecting a quantity of carbon dioxide into the block composition; and
setting the block composition in the mold for a predetermined period of time.

2. The method of claim 1, further comprising the step of compressing the block composition prior to the curing step.

3. The method of claim 1 further comprising the step of heating the block composition during the curing step.

4. The method of claim 3, wherein the block composition is cured in an autoclave, operational for controlling one or more of the temperature, humidity, or carbon dioxide environment.

5. The method of claim 1, further comprising the step of coating one or more surfaces of the structural block with a lime coating after the structural block has set.

6. The method of claim 1, wherein the members are constructed to have a square cross section and the mold is adapted for forming a plurality of apertures having a square cross section.

7. The method of claim 1, wherein the members are constructed to have a round cross section and the mold is adapted for forming a plurality of apertures having a round cross section.

8. The method of claim 1, further comprising the step of forming a hollow cavity in one or more of the members.

9. The method of claim 1, further comprising the step of forming one or more of the members with a slotted configuration.

10. The method of claim 1, further comprising the step of forming the members from a material which is substantially non-compressible along its length and contributes to the load bearing attributes of the structural block under compression.

11. The method of claim 1, further comprising the step of forming the members from wooden materials, organic fibers, inorganic fibers, composite materials, polymers, metallic materials, polymers, plastics, resins, or any combination thereof.

12. The method of claim 11, wherein the wooden material is fir, spruce, pine cedar, or any combination thereof.

13. The method of claim 1, wherein the primary fibrous material comprises organic materials.

14. The method of claim 13, wherein the primarily fibrous material comprises hemp hurd, flax, corn stock, cereal grain, straw, cellulose strands or any combination thereof.

15. The method of claim 1, wherein the primarily fibrous material comprises inorganic materials.

16. The method of claim 15, wherein the primarily fibrous material comprises plastic, extruded polystyrene foam, metals, carbon filaments or any combination thereof.

17. The method of claim 1, wherein the primarily fibrous material comprises a combination of inorganic and organic materials

18. The method of claim 1, wherein the primarily lime based material comprises one or more of hydraulic lime or hydrated lime.

19. The method of claim 1, further comprising adding an additional binding agent during the step of mixing the primarily fibrous material with the primarily lime based material.

20. The method of claim 19, wherein the additional binding agent is a polymer based agent, polyester resins, cement, resins, silica sand, pozzolans, or any combination thereof.

21. A method for manufacturing an interlocking structural block comprising:
positioning a plurality of members into a mold, such that one end of a member extends from one surface of the structural block with an opposite end of the member terminating partway within the structural block, wherein the mold is adapted for forming a plurality of apertures extending within the structural block from an opposing surface of the structural block, the apertures adapted for engaging with an extending end of an adjacent structural block;
mixing hemp hurd, flax, hydraulic lime and hydrated lime for forming a block composition;
applying the block composition into the mold;
compressing the block composition;
curing the block composition in the mold, such that the block composition is allowed to form around the plurality of members;
injecting a quantity of carbon dioxide into the block composition; and
setting the block composition in the mold for a predetermined period of time.
